(19) United States
(12) Patent Application Publication
(10) Pub. No.: US 2026/0348765 A1
(43) Pub. Date: Nov. 5, 2026

(54) Temperature Logger

(71) Applicant: SEIKO EPSON CORPORATION, Tokyo (JP)

(72) Inventors: Ryuta NISHIZAWA, Nagano (JP); Yasuhiro SUDO, Chino (JP); Toshiya USUDA, Ina (JP)

(21) Appl. No.: 19/664,020

(22) Filed: Apr. 30, 2026

(30) Foreign Application Priority Data
May 1, 2025 (JP) 2025-076111

(51) Int. Cl. G01K 1/022; G01D 9/00; G01D 11/24

(52) U.S. Cl. CPC G01K 1/022; G01D 9/005; G01D 11/245; G01K 2215/00

(57) ABSTRACT

A temperature logger includes a circuit device and a package housing the circuit device. The circuit device includes a timing circuit that tracks time to generate time data, a temperature sensor that detects a temperature and outputs a temperature signal corresponding to the detected temperature, and a memory circuit that stores time information based on the time data and temperature information based on the temperature signal in association with each other. The temperature logger has a heat capacity less than or equal to 0.4 [J/K].

The present application is based on, and claims priority from JP Application Serial Number 2025-076111, filed May 1, 2025, the disclosure of which is hereby incorporated by reference herein in its entirety.

### BACKGROUND

### 1. Technical Field

The present disclosure relates to a temperature logger.

### 2. Related Art

JP-A-2023-161717 discloses a real-time clock module including a timing circuit that outputs time data, a selection circuit that selects at least one of a plurality of types of event data as target event data to be stored and selects target time data corresponding to one or more of time digits of the time data as a target to be stored, and a memory circuit that stores the target time data and the target event data.

A temperature logger that stores time information and temperature information in a memory is required to measure the temperature of an object to be measured as accurately as possible. When the temperature logger is attached to the object to be measured or installed near the object to be measured, the temperature of the object to be measured may fluctuate. However, JP-A-2023-161717 does not disclose the issue of reducing a fluctuation in the temperature of an object to be measured.

### SUMMARY

According to an aspect of the present disclosure, there is provided a temperature logger including a circuit device and a package housing the circuit device. The circuit device includes a timing circuit that tracks time to generate time data, a temperature sensor that detects a temperature and outputs a temperature signal corresponding to the detected temperature, and a memory circuit that stores time information based on the time data and temperature information based on the temperature signal in association with each other, and the temperature logger has a heat capacity less than or equal to 0.4 [J/K].

### BRIEF DESCRIPTION OF THE DRAWINGS

FIG. 1 is a diagram illustrating an example of a configuration of a system including a temperature logger.

FIG. 2 is a functional block diagram of the temperature logger according to a first embodiment.

FIG. 3 is a diagram illustrating an example of temperature information stored in association with time information.

FIG. 4 is a perspective view of the temperature logger according to the first embodiment.

FIG. 5 is a top view of the temperature logger according to the first embodiment.

FIG. 6 is a cross-sectional view taken along line VI-VI illustrated in FIGS. 4 and 5.

FIG. 7 is a diagram illustrating an example of the temperature of an object to be measured that changes over time.

FIG. 8 is a functional block diagram of a temperature logger according to a second embodiment.

FIG. 9 is a top view of the temperature logger according to the second embodiment.

FIG. 10 is a cross-sectional view taken along line X-X illustrated in FIG. 9.

FIG. 11 is a functional block diagram of a temperature logger according to a third embodiment.

FIG. 12 is a top view of the temperature logger according to the third embodiment.

FIG. 13 is a cross-sectional view taken along line XIII-XIII illustrated in FIG. 12.

FIG. 14 is a cross-sectional view of a temperature logger according to a modification.

FIG. 15 is a cross-sectional view of a temperature logger according to another modification.

### DESCRIPTION OF EMBODIMENTS

Hereinafter, preferred embodiments of the present disclosure will be described in detail with reference to the drawings. It should be noted that the embodiments described below do not unduly limit the contents of the present disclosure described in the appended claims. In addition, not all of the configurations described below are necessarily essential components of the present disclosure.

### 1. First Embodiment

### 1-1. Overview of Temperature Logger

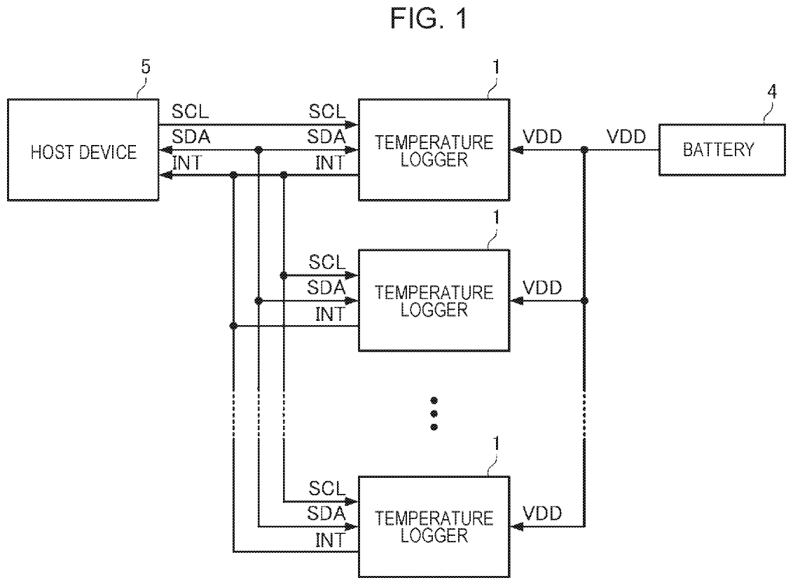

FIG. 1 is a diagram illustrating an example of a configuration of a system including a temperature logger 1 according to the present embodiment. As illustrated in FIG. 1, the system illustrated in FIG. 1 includes a plurality of temperature loggers 1, a battery 4, and a host device 5. The battery 4 is, for example, a coin battery or the like, and supplies electric power to each of the plurality of temperature loggers 1. Specifically, each of the plurality of temperature loggers 1 operates with a power supply voltage VDD supplied from the battery 4. Each of the plurality of temperature loggers 1 is coupled to the host device 5. The system illustrated in FIG. 1 may include only one temperature logger 1.

The temperature logger 1 acquires temperature information while continuously performing an operation of tracking time, and records the acquired temperature information and the time in association with each other. Then, the temperature logger 1 transmits the recorded information to the host device 5. For example, the host device 5 and the temperature logger 1 communicate with each other via an I²C bus, while the host device 5 serves as a master and the temperature logger 1 serves as a slave. I²C is an abbreviation for Inter-Integrated Circuit. The host device 5 is implemented by, for example, an MCU or an MPU. MCU is an abbreviation for Micro Controller Unit. MPU is an abbreviation for Micro Processor Unit. The temperature logger 1 may acquire and record the temperature information at each timing specified by the host device 5, or may acquire and record the temperature information at a predetermined time interval.

### 1-2. Functional Configuration of Temperature Logger

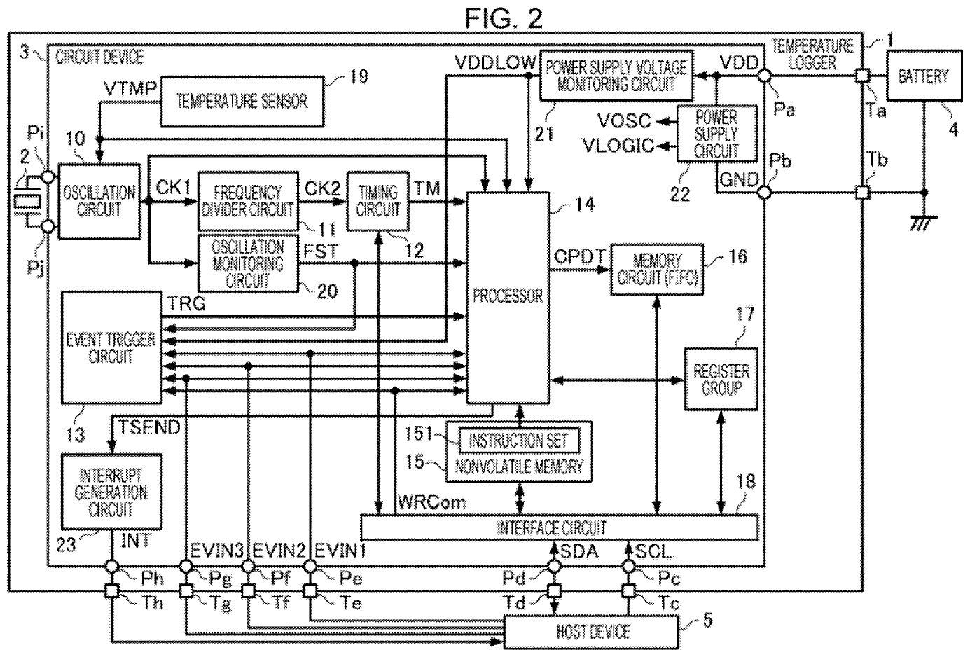

FIG. 2 is a functional block diagram of the temperature logger 1 according to the first embodiment. As illustrated in FIG. 2, the temperature logger 1 includes a plurality of external terminals including external terminals Ta to Th. The external terminal Ta is coupled to the battery 4. The power supply voltage VDD is supplied to the temperature logger 1 from the battery 4 via the external terminal Ta. The external terminal Tb is coupled to the ground. A ground voltage GND is supplied to the temperature logger 1 via the external terminal Tb. The external terminals Tc to Th are coupled to the host device 5. The temperature logger 1 communicates with the host device 5 via the external terminals Tc to Th.

As illustrated in FIG. 2, the temperature logger 1 includes a resonator element 2 and a circuit device 3.

The resonator element 2 may be a tuning-fork type quartz crystal resonator element, an AT-cut quartz crystal resonator element, an SC-cut quartz crystal resonator element, or the like, or may be a SAW resonator or a piezoelectric resonator element other than a quartz crystal resonator element. SAW is an abbreviation for Surface Acoustic Wave. The resonator element 2 may be a MEMS resonator element made of a silicon semiconductor. MEMS is the abbreviation for Micro Electro Mechanical Systems. For example, the resonator element 2 may be an electrostatic drive type MEMS resonator element that uses a Coulomb force.

As illustrated in FIG. 2, the circuit device 3 includes a plurality of terminals including terminals Pa to Pj. The terminals Pa to Ph are coupled to the external terminals Ta to Th, respectively. The terminals Pi and Pj are coupled to the resonator element 2.

As illustrated in FIG. 2, the circuit device 3 includes an oscillation circuit 10, a frequency divider circuit 11, a timing circuit 12, an event trigger circuit 13, a processor 14, a nonvolatile memory 15, a memory circuit 16, a register group 17, an interface circuit 18, a temperature sensor 19, an oscillation monitoring circuit 20, a power supply voltage monitoring circuit 21, a power supply circuit 22, and an interrupt generation circuit 23. However, the circuit device 3 may have a configuration in which some of these components are omitted or changed or in which another component is added. In the present embodiment, the circuit device 3 is a single-chip integrated circuit, but may include a multi-chip integrated circuit, or at least a portion of the circuit device 3 may include a discrete component.

The power supply voltage monitoring circuit 21 monitors the power supply voltage VDD, determines whether the power supply voltage VDD is lower than or equal to a predetermined voltage value VT, and outputs a power supply voltage drop signal VDDLOW. In the present embodiment, the power supply voltage monitoring circuit 21 outputs a high-level power supply voltage drop signal VDDLOW if the power supply voltage monitoring circuit 21 determines that the power supply voltage VDD is lower than or equal to the voltage value VT, and outputs a low-level power supply voltage drop signal VDDLOW if the power supply voltage monitoring circuit 21 determines that the power supply voltage VDD is higher than the voltage value VT. In this way, the power supply voltage monitoring circuit 21 monitors the power supply voltage VDD and generates the power supply voltage drop signal VDDLOW that is power supply voltage monitoring data.

The power supply circuit 22 is coupled to the terminals Pa and Pb, and the power supply voltage VDD and the ground voltage GND are supplied to the power supply circuit 22 from the terminals Pa and Pb, respectively. The power supply circuit 22 generates a stabilized power supply voltage VOSC having a constant voltage value and a stabilized power supply voltage VLOGIC having a constant voltage value based on the power supply voltage VDD and the ground voltage GND. The power supply circuit 22 is implemented by, for example, a regulator. Although not illustrated, the ground voltage GND is also supplied to each section of the circuit device 3 other than the power supply circuit 22, and serves as a reference voltage for an operation of each section of the circuit device 3.

The power supply voltage VOSC is supplied to the oscillation circuit 10. The power supply voltage VLOGIC is supplied to the frequency divider circuit 11, the timing circuit 12, the event trigger circuit 13, the processor 14, the nonvolatile memory 15, the memory circuit 16, the register group 17, the interface circuit 18, the temperature sensor 19, the oscillation monitoring circuit 20, the power supply voltage monitoring circuit 21, and the interrupt generation circuit 23.

The temperature sensor 19 detects a temperature and outputs a temperature signal VTMP corresponding to the detected temperature. The temperature signal VTMP may be a digital signal or an analog signal.

The oscillation circuit 10 generates a first clock signal CK1 by vibrating the resonator element 2. Specifically, the oscillation circuit 10 is electrically coupled to both ends of the resonator element 2 via the terminals Pi and Pj, and amplifies and feeds back a signal output from the resonator element 2 so as to vibrate the resonator element 2 and output the first clock signal CK1. In addition, the oscillation circuit 10 has a built-in temperature compensation circuit that keeps the frequency of the first clock signal CK1 constant regardless of the temperature by changing the frequency of the first clock signal CK1 according to the temperature signal VTMP output from the temperature sensor 19. In the present embodiment, the frequency of the first clock signal CK1 is 32.768 kHz. However, the frequency of the first clock signal CK1 is not particularly limited.

The oscillation monitoring circuit 20 monitors the first clock signal CK1, determines whether the oscillation circuit 10 has stopped an oscillation operation, and outputs an oscillation stop signal FST. For example, when the logic level of the first clock signal CK1 is not inverted continuously for a predetermined period of time, the oscillation monitoring circuit 20 determines that the oscillation circuit 10 has stopped the oscillation operation, and outputs a high-level oscillation stop signal FST. Further, when the logic level of the first clock signal CK1 is inverted within the predetermined period of time, the oscillation monitoring circuit 20 determines that the oscillation circuit 10 has not stopped the oscillation operation, and outputs a low-level oscillation stop signal FST. As described above, the oscillation monitoring circuit 20 monitors the first clock signal CK1 and generates the oscillation stop signal FST that is oscillation monitoring data.

The frequency divider circuit 11 divides the frequency of the first clock signal CK1 to generate a second clock signal CK2 having a desired frequency. In the present embodiment, the frequency division ratio of the frequency divider circuit 11 is 32, and the frequency of the second clock signal CK2 is 1.024 kHz. However, the frequency division ratio of the frequency divider circuit 11 and the frequency of the second clock signal CK2 are not particularly limited.

The timing circuit 12 tracks time based on the second clock signal CK2 to generate time data TM. In the present embodiment, the time data TM includes, as time digits, 1/1024 second, second, minute, hour, day, month, and year. Specifically, the time data TM includes sub-second data in a binary format representing time in units of 1/1024 seconds in a range from 0 to 1023, second data in a BCD format representing time in units of seconds in a range from 0 to 59, minute data in a BCD format representing time in units of minutes in a range from 0 to 59, hour data in a BCD format representing time in units of hours in a range from 0 to 23, day data in a BCD format representing time in units of days in a range from 1 to 31, month data in a BCD format representing time in units of months in a range from 1 to 12, and year data in a BCD format representing time in units of years from 0 to 9999. BCD is an abbreviation for Binary Coded Decimal.

A first event signal EVIN1, a second event signal EVIN2, and a third event signal EVIN3 are input to the event trigger circuit 13 from the host device 5 via the terminals Pe, Pf, and Pg, respectively. An event command detection signal WRCom output from the interface circuit 18 is input to the event trigger circuit 13. The power supply voltage drop signal VDDLOW output from the power supply voltage monitoring circuit 21 is input to the event trigger circuit 13. The oscillation stop signal FST output from the oscillation monitoring circuit 20 is input to the event trigger circuit 13. When a rising edge of at least one of the event command detection signal WRCom, the power supply voltage drop signal VDDLOW, and the oscillation stop signal FST occurs, the event trigger circuit 13 outputs a high-pulse event trigger signal TRG. The event trigger circuit 13 outputs the high-pulse event trigger signal TRG even when at least one of a specified edge of the first event signal EVIN1, a specified edge of the second event signal EVIN2, and a specified edge of the third event signal EVIN3 occurs. A rising edge, a falling edge, or both rising and falling edges of each of the first event signal EVIN1, the second event signal EVIN2, and the third event signal EVIN3 for generation of the event trigger signal TRG may be specified by an event control register included in the register group 17.

The processor 14 generates capture data CPDT in which time information based on the time data TM generated by the timing circuit 12 and temperature information based on the temperature signal VTMP output from the temperature sensor 19 are associated with each other, and stores the generated capture data CPDT into the memory circuit 16. Therefore, the memory circuit 16 stores the time information and the temperature information in association with each other.

For example, the time information may be data corresponding to one or more of the time digits of the time data TM. The time information may be, for example, data corresponding to each of the digits of year, month, day, hour, minute, and second. In a case where the temperature signal VTMP is an analog signal, the temperature information may be, for example, a digital value obtained by converting the voltage of the temperature signal VTMP. In a case where the temperature signal VTMP is a digital signal, the temperature information may be, for example, the digital value itself. For example, the processor 14 may generate the capture data CPDT at a time interval set in a predetermined register included in the register group 17 and sequentially store the capture data CPDT into the memory circuit 16.

In addition, the processor 14 selects, in response to the event trigger signal TRG output from the event trigger circuit 13, at least one of a plurality of types of event data as target event data to be stored, generates capture data CPDT in which the time information based on the time data TM is associated with the selected target event data, and stores the generated capture data CPDT into the memory circuit 16. That is, the processor 14 performs a time stamp process of storing the time information and the target event data in association with each other into the memory circuit 16 in response to the event trigger signal TRG.

The plurality of types of event data may include the power supply voltage drop signal VDDLOW that is the power supply voltage monitoring data generated by the power supply voltage monitoring circuit 21. In addition, the plurality of types of event data may include the oscillation stop signal FST that is the oscillation monitoring data generated by the oscillation monitoring circuit 20. Further, the plurality of types of event data may include data corresponding to an external input signal input from the outside of the temperature logger 1. For example, the external input signal is the first event signal EVIN1, the second event signal EVIN2, the third event signal EVIN3, and an event generation command for generating an event, and the data corresponding to the external input signal is the first event signal EVIN1, the second event signal EVIN2, the third event signal EVIN3, and the event command detection signal WRCom.

The nonvolatile memory 15 stores an instruction set 151 for specifying the target event data, and the processor 14 selects the target event data based on the instruction set 151 in synchronization with the first clock signal CK1, and the processor 14 stores the time information and the target event data in association with each other into the memory circuit 16. That is, the instruction set 151 includes a plurality of instruction codes necessary for the processor 14 to perform the time stamp process. The nonvolatile memory 15 may be an electrically non-writable ROM such as a mask ROM, or may be an electrically writable ROM such as an EEPROM. EEPROM is an abbreviation for Electrically Erasable Programmable Read Only Memory.

The instruction set 151 may include an instruction code for specifying a time interval at which the processor 14 stores the time information and the temperature information in association with each other into the memory circuit 16, and the processor 14 may set the time interval in a predetermined register included in the register group 17 by executing the instruction code.

When the time stamp process based on the event trigger signal TRG is ended, the processor 14 outputs a time stamp end signal TSEND to the interrupt generation circuit 23.

The interrupt generation circuit 23 generates an interrupt signal INT based on the time stamp end signal TSEND, and outputs the interrupt signal INT to the host device 5 via the terminal Ph of the circuit device 3. Upon receiving the interrupt signal INT, the host device 5 performs a predetermined interrupt process. For example, the host device 5 transmits, to the temperature logger 1, a command for requesting reading of data of a time stamp and receives the capture data CPDT stored in the memory circuit 16 from the temperature logger 1.

In order to reduce the power consumption of the entire system, the host device 5 shifts to a sleep state when the host device 5 does not perform processing. Upon receiving the interrupt signal INT in the sleep state, the host device 5 returns from the sleep state and performs processing of reading the data of the time stamp. When the necessary processing is ended, the host device 5 shifts to the sleep state again.

The interface circuit 18 is an interface circuit for communication between the temperature logger 1 and the host device 5. In the communication by the interface circuit 18, the host device 5 serves as a master and the temperature logger 1 serves as a slave. That is, the interface circuit 18 functions as a slave interface for the host device 5. In the present embodiment, the interface circuit 18 is compatible with the I²C bus, and communicates with the host device 5 based on a serial clock signal SCL input via the terminal Pc of the circuit device 3 and a serial data signal SDA input and output via the terminal Pd of the circuit device 3. However, the interface circuit 18 may be compatible with another serial bus such as an SPI bus, or may be compatible with a parallel bus. SPI is an abbreviation for Serial Peripheral Interface.

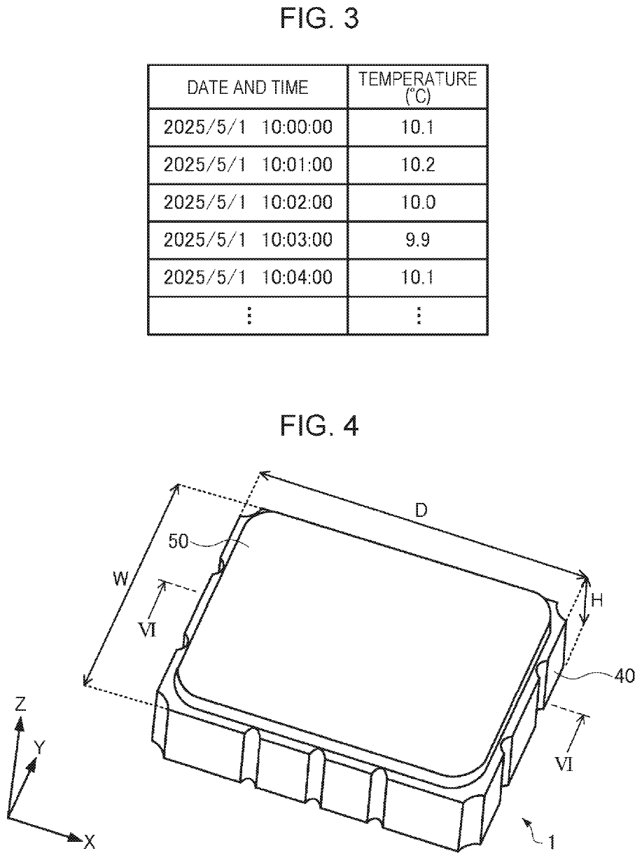

The memory circuit 16 is a semiconductor memory, and may be an SRAM or a DRAM or may be an electrically writable nonvolatile memory such as an EEPROM. SRAM is an abbreviation for Static Random Access Memory, and DRAM is an abbreviation for Dynamic Random Access Memory. The memory circuit 16 functions as an N-stage FIFO memory circuit capable of storing N sets of capture data CPDT. FIFO is an abbreviation for First In First Out. That is, the memory circuit 16 is capable of simultaneously storing the N sets of capture data CPDT. Therefore, for example, as illustrated in FIG. 3, a plurality of sets of capture data CPDT in which time information and temperature information are associated with each other are simultaneously stored in the memory circuit 16.

The capture data CPDT may be stored in the memory circuit 16 or may be transmitted to the host device 5 via the interface circuit 18 without being stored in the memory circuit 16.

### 1-3. Structure of Temperature Logger

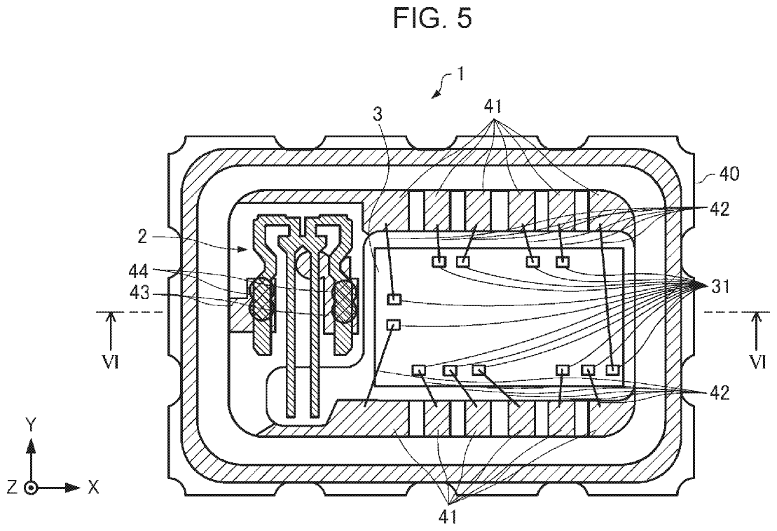

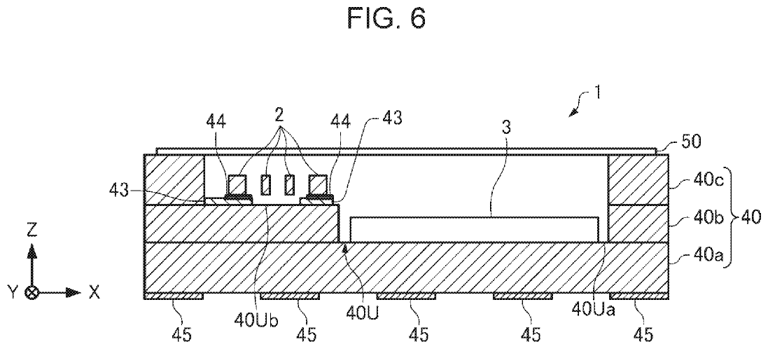

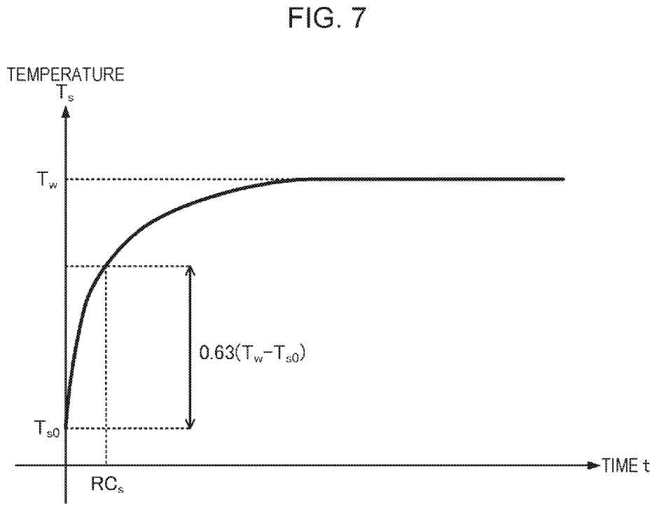

FIGS. 4 to 6 are diagrams illustrating an example of a structure of the temperature logger 1. FIG. 4 is a perspective view of the temperature logger 1. FIG. 5 is a top view of the temperature logger 1. FIG. 6 is a cross-sectional view taken along line VI-VI illustrated in FIGS. 4 and 5. FIGS. 4 to 6 illustrate an X direction, a Y direction, and a Z direction that are orthogonal to each other so that the relationship between the orientations of components of the temperature logger 1 can be understood.

As illustrated in FIGS. 4 to 6, the temperature logger 1 includes the resonator element 2, the circuit device 3, a package 40, and a lid 50. FIG. 5 is a top view of the temperature logger 1 with the lid 50 removed.

The temperature logger 1 has a single seal structure, and the package 40 is a container housing the resonator element 2 and the circuit device 3 in the same space. The package 40 includes a substrate 40a, a frame-shaped sidewall 40b joined to the substrate 40a, and a frame-shaped sidewall 40c joined to the frame-shaped sidewall 40b. The substrate 40a and the frame-shaped sidewalls 40b and 40c form a recessed portion 40U. The resonator element 2 and the circuit device 3 are housed in an airtight internal space formed by covering the recessed portion 40U with the lid 50. Thus, it is possible to protect the resonator element 2 and the circuit device 3 from an impact and an external environment, particularly, from dust, moisture, humidity, and the like. Although not particularly limited, the package 40 may be made of ceramics such as alumina, and the lid 50 may be made of a metal material such as Kovar.

The atmosphere of the internal space is not particularly limited, but the internal space is preferably, for example, in a reduced-pressure state where the atmosphere of the internal space is replaced with an inert gas such as nitrogen or argon and where the pressure is reduced with respect to the atmospheric pressure. Further, the internal space is preferably in a state closer to a vacuum state. Thus, the viscous resistance is reduced, the Q value of the resonator element 2 can be effectively increased, and the oscillation characteristics of the resonator element 2 are improved. However, the atmosphere of the internal space is not limited thereto, and the internal space may be in an atmospheric pressure state or a pressurized state.

The recessed portion 40U has a step, and includes a recessed portion 40Ua formed by the substrate 40a and the frame-shaped sidewall 40b, and a recessed portion 40Ub formed by the frame-shaped sidewalls 40b and 40c and having an opening smaller than that of the recessed portion 40Ua. A plurality of electrodes 45 are disposed on a bottom surface of the substrate 40a, namely, a bottom surface of the package 40. In addition, a plurality of electrodes 41 and two electrodes 43 are disposed on a bottom surface of the recessed portion 40Ub, namely, an upper surface of the frame-shaped sidewall 40b. Each of the two electrodes 43 is electrically coupled, via wiring (not illustrated) disposed in the package 40, to a corresponding one of two electrodes 41 closest to the resonator element 2 among the plurality of electrodes 41. In addition, each of the plurality of electrodes 41 other than the two electrodes 41 is coupled to a corresponding one of the plurality of electrodes 45 via wiring (not illustrated) disposed in the package 40. The plurality of electrodes 45 correspond to a plurality of terminals including the external terminals Ta to Th illustrated in FIG. 2.

In FIGS. 4 to 6, the resonator element 2 is a tuning-fork type quartz crystal resonator element, and each of two support arms of the resonator element 2 is joined to a corresponding one of the two electrodes 43 via a conductive joint member 44. That is, each of the support arms of the resonator element 2 is fixed to and electrically coupled to a corresponding one of the electrodes 43. The joint member 44 is not particularly limited as long as the joint member 44 has both conductivity and joint properties. For example, various metal bumps such as a gold bump, a silver bump, a copper bump, and a solder bump, conductive adhesives in which a conductive filler such as a silver filler is dispersed in various adhesives such as a polyimide-based adhesive; an epoxy-based adhesive, a silicone-based adhesive, and an acrylic adhesive, and the like can be used as the joint member 44.

An electrode pattern (not illustrated) is formed on each of the two support arms and two vibrating arms of the resonator element 2. Then, a signal generated in one of the electrode patterns is supplied from one of the electrodes 43 to the Pj terminal of the circuit device 3, and the oscillation circuit 10 included in the circuit device 3 amplifies the signal and supplies the amplified signal from the Pi terminal to the resonator element 2 via the other of the electrodes 43, whereby the two vibrating arms of the resonator element 2 continue to vibrate like a tuning fork.

The circuit device 3 is the single-chip integrated circuit and is fixed to a bottom surface of the recessed portion 40Ua, namely, an upper surface of the substrate 40a, via an adhesive or the like such that a surface on which a plurality of pads 31 are disposed is an upper surface of the circuit device 3. Each of the plurality of pads 31 is coupled to a corresponding one of the plurality of electrodes 41 via a bonding wire 42. The pads 31 correspond to the plurality of terminals including the terminals Pa to Pj illustrated in FIG. 2.

In FIGS. 4 to 6, the resonator element 2 is a tuning fork type quartz crystal resonator element, but is not limited thereto, and may be an AT-cut quartz crystal resonator element, an SC-cut quartz crystal resonator element, a BT-cut quartz crystal resonator element, a surface acoustic wave resonator, another piezoelectric resonator element, an electrostatic drive type MEMS resonator element, or the like. In FIGS. 4 to 6, the circuit device 3 is the single-chip integrated circuit, but at least the portion of the circuit device 3 may include the discrete component. In FIGS. 4 to 6, the circuit device 3 is implemented via wire bonding, but may be implemented via flip chip bonding (FCB). In a case where the circuit device 3 is implemented via the wire bonding, it is possible to visually recognize whether the pads 31 are coupled to the electrodes 41, an inspection in manufacturing is simple, and the reliability is high. Meanwhile, in a case where the circuit device 3 is implemented via the FCB, the bonding wires 42 are not required, which is advantageous in reducing the height and size of the package 40.

In the temperature logger 1 having the structure described above, the package 40 that is small and inexpensive can be used. As illustrated in FIG. 4, the package 40 has a substantially rectangular parallelepiped shape, and when the lengths of three sides of the substantially rectangular parallelepiped are D [mm], W [mm], and H [mm], dimensions of the package 40 are expressed by D [mm]×W [mm]×H [mm]. In addition, the package 40 has a substantially rectangular shape in plan view, and the dimensions of the package 40 are expressed by D [mm]×W [mm]. For example, the package 40 may have dimensions of 7 mm×5 mm, 5 mm×3.2 mm, or 3.2 mm×2.5 mm in plan view. At present, packages having a size of 7 mm×5 mm, 5 mm×3.2 mm, or 3.2 mm×2.5 mm are widely spread. In a case where the package 40 has any one of these sizes, it is possible to enhance convenience and versatility.

The circuit device 3 having the configuration illustrated in FIG. 2 can be housed in, for example, the package 40 together with the resonator element 2 in a case where the package 40 has dimensions of 3.2 mm×2.5 mm×2.1 mm. In addition, in a case where the circuit device 3 has various functions other than the recording of the temperature information and the event data, or in a case where the temperature logger 1 has various sensors, there is a possibility that the dimensions of the package 40 may be large. However, even in such a case, for example, the small package 40 can have dimensions of 5 mm×3.2 mm×2.8 mm or 7 mm×5 mm×3.3 mm and can be used.

### 1-4. Heat Capacity of Temperature Logger

In order to maintain the quality of a product to be transported, strict control of a temperature in a space in which the product is stored during the transport may be required. If the quality of the transported product has deteriorated, inappropriate temperature management during the transport is suspected as the cause of the deterioration. In order to enable determination as to whether the temperature management during the transport has been appropriately performed, the temperature logger 1 is used. If the quality of the transported product has deteriorated, a transport requester who has requested the transport of the product can determine whether the temperature management during the transport has been appropriately performed, based on temperature information stored in time series in association with time information in the temperature logger 1. Meanwhile, a transporter who transports the product can effectively use the time series of the temperature information stored in the temperature logger 1 as evidence for proving that the temperature management has been appropriately performed, and can differentiate the transporter from other transporters by promoting high transport quality.

Further, since the temperature logger 1 according to the present embodiment is small and inexpensive, for example, in transport of a large number of products, the products can be transported in a state where each of a large number of temperature loggers 1 is attached to a corresponding one of the products. In this way, the transport requester and the transporter can determine whether the temperature management of each of the products has been appropriately performed during the transport, based on time series of temperature information stored in a corresponding one of the temperature loggers 1.

As described above, the temperature logger 1 according to the present embodiment provides various advantages to both the transport requester and the transporter. However, when the temperature logger 1 is attached to a product, the temperature of the product may change due to the temperature logger 1, which may make it difficult to manage the temperature of the product.

In a case where the temperature of an object to be measured such as a product is constant, and the mass, specific heat, and initial temperature of the object to be measured are m1, c1, and t1, respectively, the mass, specific heat, and initial temperature of the temperature logger 1 are m2, c2, and t2, respectively, and the equilibrium temperature of the object to be measured and the temperature logger 1 after contact between the object to be measured and the temperature logger 1 is t, Equation (1) is obtained from the Law of Conservation of Heat.

$$m 1 \cdot c 1 \cdot ( t 1 - t ) = m 2 \cdot c 2 \cdot ( t - t 2 ) \qquad ( 1 )$$

In Equation (1), m1·c1 is the heat capacity C1 of the object to be measured, and m2·c2 is the heat capacity C2 of the temperature logger 1. Thus, Equation (2) is obtained from Equation (1).

$$C 1 \cdot ( t 1 - t ) = C 2 \cdot ( t - t 2 ) \qquad ( 2 )$$

In Equation (2), t1−t is a change Δt1 in the temperature of the object to be measured. Thus, Equation (3) is obtained from Equation (2).

$$Δ t 1 = \frac{C 2}{C 1} \cdot ( t - t 2 ) \qquad ( 3 )$$

According to Equation (3), in a case where the heat capacity C2 of the temperature logger 1 is greater than the heat capacity C1 of the object to be measured, the temperature of the object to be measured changes only due to the attachment of the temperature logger 1 to the object to be measured. Therefore, if the heat capacity C2 is high, the temperature logger 1 cannot accurately measure the temperature of the object to be measured. Therefore, the heat capacity C2 is preferably as low as possible. According to Equation (3), if the temperature t2 of the temperature logger 1 is set to be close to the temperature t1 of the object to be measured in advance, it is not necessary to provide a constraint condition for the heat capacity C2. However, the temperature t1 is unknown at the time of attaching the temperature logger 1 to the object to be measured, and it is difficult to set the temperature t2 to be close to the temperature t1.

Meanwhile, in a case where the temperature of the object to be measured changes due to heat dissipation or heat absorption, the temperature Ts of the object to be measured changes over time t, for example, as illustrated in FIG. 7, and is expressed by Equation (4). In FIG. 7 and Equation (4), T_{S0} is the initial temperature of the object to be measured, and T_{W} is the equilibrium temperature of the object to be measured and the temperature logger 1 after the contact between the object to be measured and the temperature logger 1. Further, R is heat resistance, and C_{S} is a heat capacity. The heat resistance R varies depending on the contact state between the object to be measured and the temperature logger 1.

$${T}_{s} ( t ) = {T}_{s 0} + ( {T}_{w} - {T}_{s 0} ) ( 1 - {e}^{( - \frac{t}{{RC}_{s}} )} ) \qquad ( 4 )$$

According to Equation (4), as the heat capacity C_{S} increases, a time constant τ=RC_{S} increases and performance in tracking the temperature decreases. For example, in a case where a change in the temperature of a resin mold is large due to rapid heating or cooling in measurement of changes in the temperature of the resin mold, it is necessary to reduce the heat capacity C_{S} in order for the temperature logger 1 to accurately measure and record the changes in the temperature.

On the other hand, in the temperature logger 1 according to the present embodiment, as described above, for example, the small package 40 having dimensions of 3.2 mm×2.5 mm×2.1 mm, 5 mm×3.2 mm×2.8 mm, 7 mm×5 mm×3.3 mm, or the like can be used. Therefore, the temperature logger 1 has a small mass and has a low heat capacity. The inventor of the present application roughly calculated the heat capacity of the temperature logger 1 when using the package 40 having the largest size of 7 mm×5 mm×3.3 mm among the above-described sizes, and the calculated heat capacity was approximately 0.2 [J/K]. In consideration of a calculation error and a manufacturing variation of the temperature logger 1, the heat capacity of the temperature logger 1 is less than or equal to 0.4 [J/K] obtained by doubling 0.2 [J/K].

In addition, in a case where the package 40 has the dimensions of 7 mm×5 mm×3.3 mm, the volume of the package 40 is 115.5 mm³. In a case where the package 40 has the dimensions of 5 mm×3.2 mm×2.8 mm, the volume of the package 40 is 44.5 mm³. Therefore, the heat capacity of the temperature logger 1 including the package 40 having the dimensions of 5 mm×3.2 mm×2.8 mm is approximately 0.08 [J/K] (~0.2 [J/K]×44.5/115.5). Therefore, in consideration of the calculation error and the manufacturing variation of the temperature logger 1, the heat capacity of the temperature logger 1 may be less than or equal to 0.16 [J/K] obtained by doubling 0.08 [J/K].

In a case where the package 40 has the dimensions of 3.2 mm×2.5 mm×2.1 mm, the volume of the package 40 is 17.1 mm³. Therefore, the heat capacity of the temperature logger 1 including the package 40 having the dimensions of 3.2 mm×2.5 mm×2.1 mm is approximately 0.03 [J/K] (~0.2 [J/K]×17.1/115.5). Therefore, in consideration of the calculation error and the manufacturing variation of the temperature logger 1, the heat capacity of the temperature logger 1 may be less than or equal to 0.06 [J/K] obtained by doubling 0.03 [J/K].

In a case where ±1% is desired to be ensured as the accuracy of measuring the temperature by the temperature logger 1, it is preferable that the heat capacity of the temperature logger 1 be less than or equal to 1/100 of the heat capacity of the object to be measured according to Equation (3). For example, since the heat capacity of the temperature logger 1 is less than or equal to 0.4 [J/K], in a case where the heat capacity of the object to be measured is greater than or equal to 40 [J/K], it is possible to ensure ±1% as the accuracy of measuring the temperature by the temperature logger 1. In addition, for example, in a case where the heat capacity of the temperature logger 1 is less than or equal to 0.16 [J/K], and the heat capacity of the object to be measured is greater than or equal to 16 [J/K], it is possible to ensure ±1% as the accuracy of measuring the temperature by the temperature logger 1. Further, for example, in a case where the heat capacity of the temperature logger 1 is less than or equal to 0.06 [J/K], and the heat capacity of the object to be measured is greater than or equal to 6 [J/K], it is possible to ensure ±1% as the accuracy of measuring the temperature by the temperature logger 1.

### 1-5. Operational Effects

As described above, the temperature logger 1 according to the first embodiment has an extremely low heat capacity less than or equal to 0.4 [J/K]. Therefore, even in a case where the temperature logger 1 is attached to an object that is to be measured and whose temperature is constant, a fluctuation in the temperature of the object to be measured is small. In addition, in a case where the temperature logger 1 is attached to an object that is to be measured and whose temperature rapidly changes, the performance in tracking the temperature of the object to be measured is not impaired. Therefore, according to the temperature logger 1 according to the first embodiment, it is possible to accurately measure and record the temperature of the object to be measured. Further, according to the temperature logger 1 according to the first embodiment, by setting the heat capacity to a value less than or equal to 0.16 [J/K], it is possible to more accurately measure and record the temperature of the object to be measured. Further, according to the temperature logger 1 according to the first embodiment, by setting the heat capacity to a value less than or equal to 0.06 [J/K], it is possible to more accurately measure and record the temperature of the object to be measured.

In addition, according to the temperature logger 1 according to the first embodiment, by setting the heat capacity to a value less than or equal to 1/100 of the heat capacity of the object to be measured, it is possible to accurately measure and record the temperature of the object, which is to be measured, with an error of +1% or less.

Further, according to the temperature logger 1 according to the first embodiment, it is possible to reduce the amount of data stored in the memory circuit 16 by setting the number of digits of the time information stored in association with the temperature information to the minimum necessary number of digits.

In addition, according to the first embodiment, since the ceramic package is used as the package 40 and an exterior is extremely hard and strong, for example, it is possible to provide the robust temperature logger 1 in which damage, a defect, or the like is unlikely to occur even when an impact is applied during transport. In addition, since the wiring can be routed inside the package 40, a printed circuit substrate or the like is not necessary. Further, since the package 40 enables hermetic sealing, it is not necessary to package the resonator element 2 or the circuit device 3. As a result, the temperature logger 1 can be reduced in size, resources can also be reduced, and thus the cost can be reduced.

### 2. Second Embodiment

For a temperature logger 1 according to a second embodiment, the same components as those described in the first embodiment are denoted by the same reference signs described in the first embodiment, descriptions that overlap with those in the first embodiment will be omitted or simplified, and contents different from those described in the first embodiment will be mainly described.

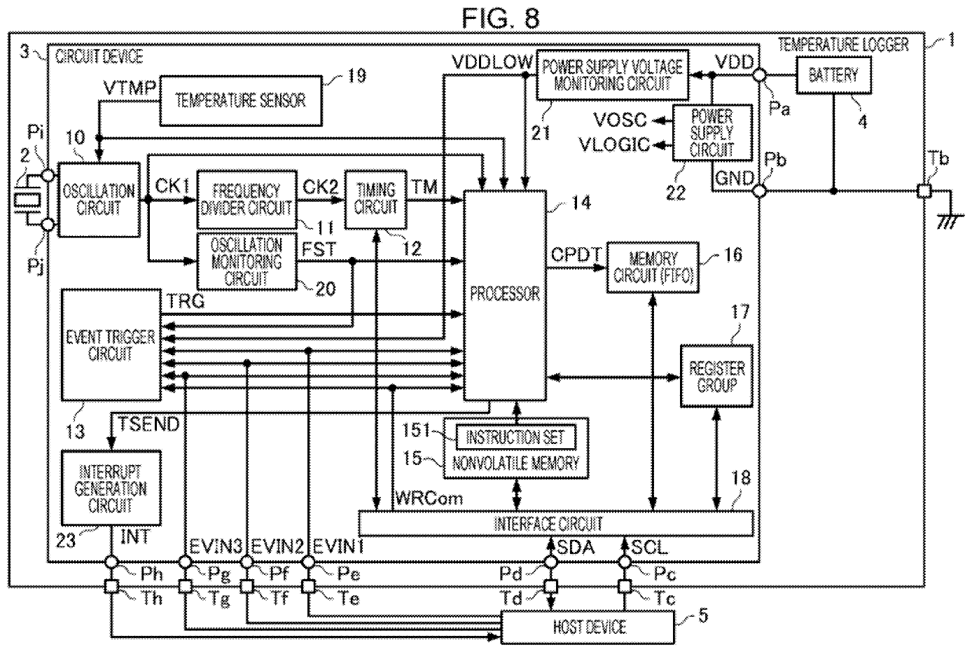

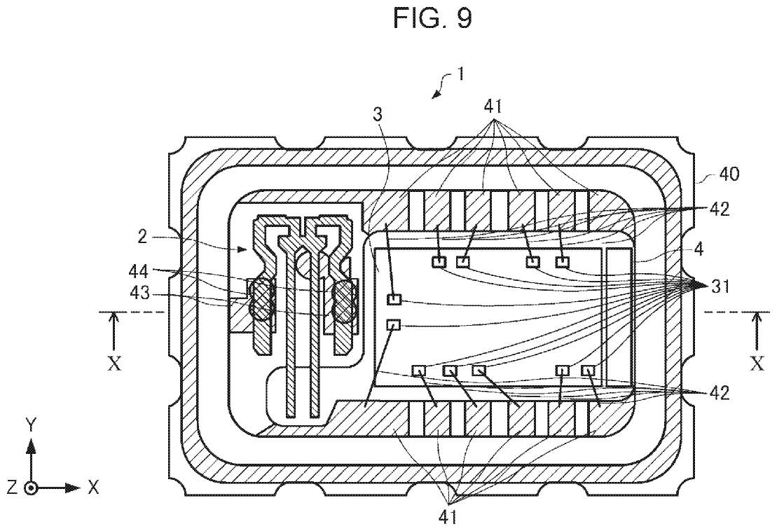

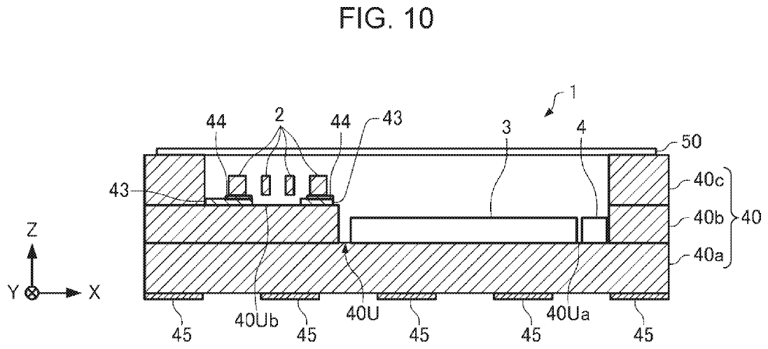

FIG. 8 is a functional block diagram of the temperature logger 1 according to the second embodiment. Since a perspective view of the temperature logger 1 according to the second embodiment is the same as FIG. 4, the illustration thereof will be omitted. FIG. 9 is a top view of the temperature logger 1 according to the second embodiment, and FIG. 10 is a cross-sectional view taken along line X-X illustrated in FIG. 9. FIG. 9 is a top view of the temperature logger 1 with the lid 50 removed. FIGS. 9 and 10 illustrate an X-direction, a Y-direction, and a Z-direction that are orthogonal to each other so that the relationship between the orientations of components of the temperature logger 1 can be understood.

As illustrated in FIGS. 8 to 10, the temperature logger 1 according to the second embodiment includes the battery 4 that supplies electric power to the circuit device 3, and the battery 4 is housed in the package 40. That is, the package 40 houses the resonator element 2, the circuit device 3, and the battery 4 in the same space. The battery 4 is, for example, a solid-state battery. As illustrated in FIG. 10, the battery 4 is fixed to the bottom surface of the recessed portion 40Ua, namely, the upper surface of the substrate 40a, via an adhesive or the like.

Other configurations and functions of the temperature logger 1 according to the second embodiment are the same as those of the temperature logger 1 according to the first embodiment, and thus the description thereof will be omitted.

According to the temperature logger 1 according to the second embodiment described above, it is possible to produce the same effects as those of the temperature logger 1 according to the first embodiment. Further, according to the temperature logger 1 according to the second embodiment, since a user does not need to prepare the battery 4, it is possible to improve convenience.

### 3. Third Embodiment

For a temperature logger 1 according to a third embodiment, the same components as those described in the first embodiment or the second embodiment are denoted by the same reference signs described in the first embodiment or the second embodiment, descriptions that overlap with those in the first embodiment or the second embodiment will be omitted or simplified, and contents different from those described in the first embodiment and the second embodiment will be mainly described.

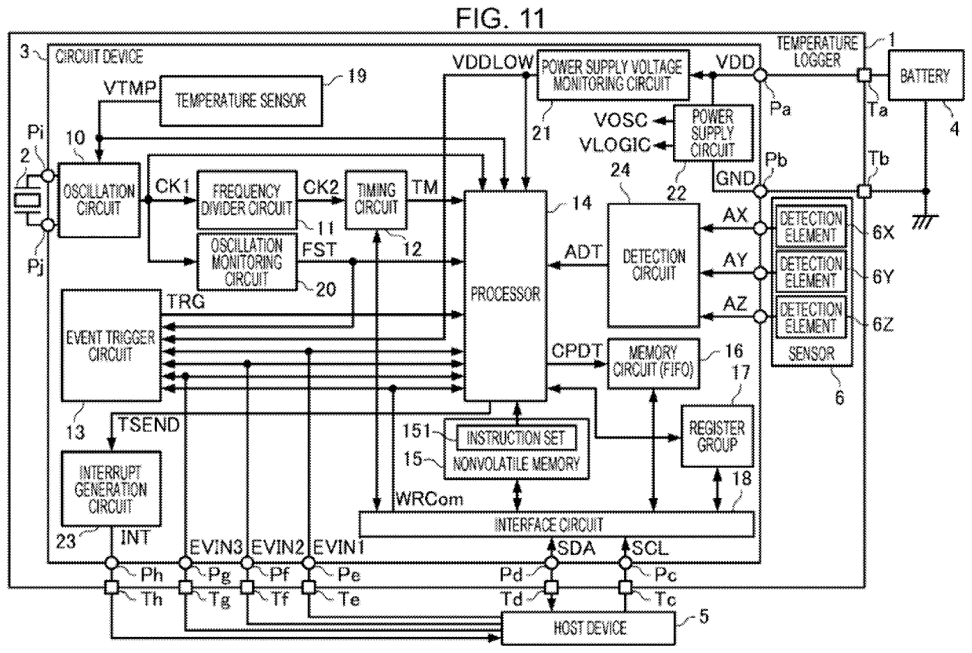

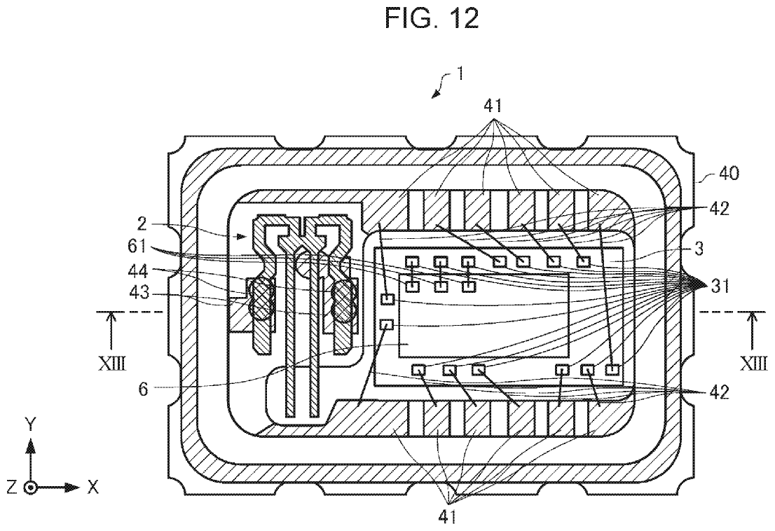

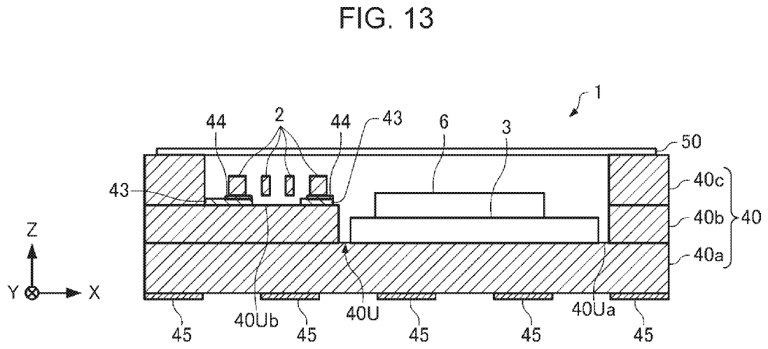

FIG. 11 is a functional block diagram of the temperature logger 1 according to the third embodiment. Since a perspective view of the temperature logger 1 according to the third embodiment is the same as FIG. 4, the illustration thereof will be omitted. FIG. 12 is a top view of the temperature logger 1 according to the third embodiment, and FIG. 13 is a cross-sectional view taken along line XIII-XIII illustrated in FIG. 12. FIG. 12 is a top view of the temperature logger 1 with the lid 50 removed. FIGS. 12 and 13 illustrate an X direction, a Y direction, and a Z direction that are orthogonal to each other so that the relationship between the orientations of components of the temperature logger 1 can be understood.

As illustrated in FIGS. 11 to 13, the temperature logger 1 according to the third embodiment includes a sensor 6 in addition to the resonator element 2 and the circuit device 3. As illustrated in FIGS. 12 and 13, the sensor 6 is joined to the upper surface of the circuit device 3 via an adhesive or the like such that the surface on which a plurality of pads 61 are formed is the upper surface of the circuit device 3. Each of the plurality of pads 61 is coupled to a corresponding one of some of the pads 31 formed in the circuit device 3 via a bonding wire.

As illustrated in FIG. 11, the sensor 6 is a three-axis accelerometer having three detection elements 6X, 6Y, and 6Z. The detection element 6X detects acceleration in the X direction and outputs an acceleration signal Ax. The detection element 6Y detects acceleration in the Y direction and outputs an acceleration signal Ay. The detection element 6Z detects acceleration in the Z direction and outputs an acceleration signal Az. The accelerometer signals Ax, Ay, and Az are, for example, analog signals such as electrical charges, currents, or voltages.

Although not illustrated, for example, the detection elements 6X, 6Y, and 6Z are MEMS elements, and each of the detection elements 6X, 6Y, and 6Z includes a comb-shaped fixed electrode fixed to a support substrate, a movable portion configured to be movable with respect to the support substrate, and a comb-shaped movable electrode fixed to the movable portion. In the detection element 6X, comb teeth of the fixed electrode are disposed facing comb teeth of the movable electrode in the X direction, and when acceleration in the X direction is applied to the detection element 6X, the movable portion moves in the X direction, distances between the comb teeth of the fixed electrode and the comb teeth of the movable electrode change, and therefore the capacitance between the comb teeth of the fixed electrode and the comb teeth of the movable electrode changes. In the detection element 6Y, comb teeth of the fixed electrode are disposed facing comb teeth of the movable electrode in the Y direction, and when acceleration in the Y direction is applied to the detection element 6Y, the movable portion moves in the Y direction, distances between the comb teeth of the fixed electrode and the comb teeth of the movable electrode change, and therefore the capacitance between the comb teeth of the fixed electrode and the comb teeth of the movable electrode changes. In the detection element 6Z, comb teeth of the fixed electrode are disposed facing comb teeth of the movable electrode in the Z direction, and when acceleration in the Z direction is applied to the detection element 6Z, the movable portion moves in the Z direction, distances between the comb teeth of the fixed electrode and the comb teeth of the movable electrode change, and therefore the capacitance between the comb teeth of the fixed electrode and the comb teeth of the movable electrode changes. The detection elements 6X, 6Y, and 6Z output the respective acceleration signals Ax, Ay, and Az corresponding to the changes in the capacitance between the comb teeth.

In FIGS. 12 and 13, the sensor 6 is configured such that the detection elements 6X, 6Y, and 6Z are housed in one package, but the sensor 6 may not have the package, and the detection elements 6X, 6Y, and 6Z may be exposed to the internal space of the package 40. The sensor 6 may be a one-axis or two-axis accelerometer.

As illustrated in FIG. 11, the circuit device 3 includes a detection circuit 24. The detection circuit 24 performs a detection process on the acceleration signals Ax, Ay, and Az output from the detection elements 6X, 6Y, and 6Z of the sensor 6 to generate a three-axis acceleration data ADT, and outputs the three-axis acceleration data ADT to the processor 14. The detection circuit 24 may include, for example, an A/D conversion circuit that performs A/D conversion on each of the acceleration signals Ax, Ay, and Az. Alternatively, the detection circuit 24 may include an amplifier circuit that amplifies each of the acceleration signals Ax, Ay, and Az, and an A/D conversion circuit that performs A/D conversion on the signals output from the amplifier circuit. Alternatively, in a case where each of the acceleration signals Ax, Ay, and Az includes a carrier-wave signal and a detection signal, the detection circuit 24 may include a detector circuit that detects the detection signals from the respective acceleration signals Ax, Ay, and Az, and an A/D conversion circuit that performs A/D conversion on the detected detection signals.

The processor 14 generates capture data CPDT in which the time information based on the time data TM generated by the timing circuit 12 and acceleration information based on the three-axis acceleration data ADT output from the detection circuit 24 are associated with each other, and stores the generated capture data CPDT into the memory circuit 16. Therefore, the memory circuit 16 stores the time information and the acceleration information in association with each other. In addition, the processor 14 may generate capture data CPDT in which the time information based on the time data TM, the temperature information based on the temperature signal VTMP, and the acceleration information based on the three-axis acceleration data ADT are associated with each other, and store the generated capture data CPDT into the memory circuit 16. That is, the memory circuit 16 may store the time information, the temperature information, and the acceleration information in association with each other. When the value of the three-axis acceleration data ADT exceeds a predetermined threshold value, the processor 14 may store, into the memory circuit 16, only capture data CPDT for a predetermined period before and after the value of the three-axis acceleration data ADT exceeds the predetermined threshold value. In this way, it is possible to reduce the capacity of the memory circuit 16.

For example, if a transported product is damaged or defective, there is a possibility that a large impact may have been applied to the product during the transport as a cause of the damage or the defect. The temperature logger 1 according to the present embodiment is used to enable determination as to whether a large impact has been applied to a product during transport. If the transported product is damaged or defective, a transport requester who requests the transport of the product can determine whether a large impact has been applied to the product during the transport, based on acceleration information stored in time series in association with time information in the temperature logger 1. Then, the transport requester can clarify the date and time when the damage, the defect, or the like occurred, the cause of the damage, the defect, or the like, where the responsibility lies, and the like, and can easily respond to a transporter who transports the product thereafter. Further, the transport requester can review the mechanical design of the product by checking the impact applied to the product during the transport, and can improve the product to a product that is less likely to be defective. In addition, the transport requester can review the shape and size of a cushioning material for protecting the product from impacts. For example, if the cushioning material can be reduced in size as a result of the review, the cost of the product and the transport cost can be reduced accordingly.

Meanwhile, the transporter who transports the product can effectively use the time series of the acceleration information stored in the temperature logger 1 as evidence for proving that the product has neither been damaged nor become defective during the transport. In addition, the transporter can prove, based on the acceleration information stored in the temperature logger 1, that the impact applied to the product during the transport is significantly lower than those when competitors transport the product, and for this reason, the transporter can differentiate the transporter from other transporters by promoting high transport quality.

Further, since the temperature logger 1 according to the present embodiment is small and inexpensive, for example, in transport of a large number of products, the products can be transported in a state where each of a large number of temperature loggers 1 is attached to a corresponding one of the products. In this way, the transport requester and the transporter can individually determine the magnitude of an impact applied to each product during transport from time series of acceleration information stored in each temperature logger 1. As described above, the temperature logger 1 according to the present embodiment provides various advantages to both the transport requester and the transporter.

Other configurations and functions of the temperature logger 1 according to the third embodiment are the same as those of the temperature logger 1 according to the first embodiment, and thus the description thereof will be omitted. Note that the sensor 6 and the detection circuit 24 may be packaged and disposed outside the temperature logger 1. The temperature logger 1 may include the battery 4 as in the second embodiment.

According to the temperature logger 1 according to the third embodiment described above, it is possible to produce the same effects as those of the temperature logger 1 according to the first embodiment or the second embodiment. Further, according to the temperature logger 1 according to the third embodiment, since the time information and the acceleration information can be recorded in association with each other. Therefore, for example, if damage or a defect occurs in an object to be measured, a user can determine whether an impact has been applied to the object to be measured, and if the impact has been applied, the user can identify the time when the impact was applied.

### 4. Modifications

The present disclosure is not limited to the embodiments, and various modifications may be made without departing from the scope of the present disclosure.

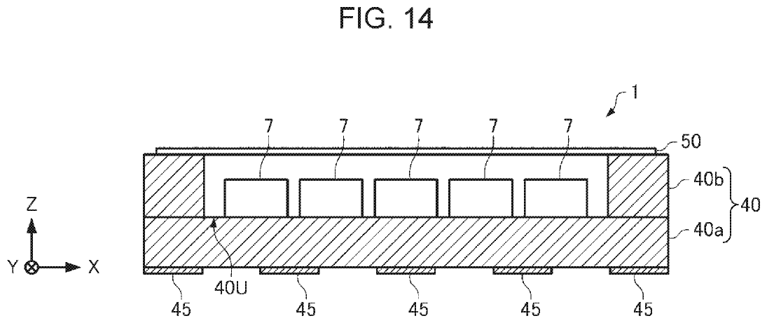

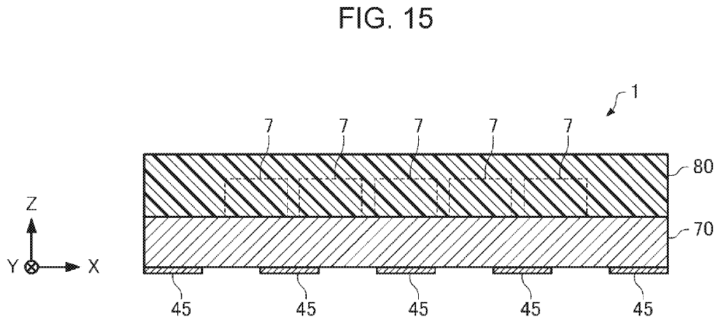

For example, in each of the embodiments described above, each of the resonator element 2 and the circuit device 3 is housed as one electronic component in the package 40, but the resonator element 2 or the circuit device 3 may not be one electronic component. The circuit device 3 is the single-chip integrated circuit, but may include a multi-chip integrated circuit, or at least a portion of the circuit device 3 may include a discrete component. FIG. 14 is a cross-sectional view illustrating an example of a structure of a temperature logger 1 according to the present modification. In the example illustrated in FIG. 14, a plurality of electronic components 7 are mounted on the substrate 40a of the package 40, and the plurality of electronic components 7 are housed in the package 40. The functions implemented by the resonator element 2 and the circuit device 3 in each of the embodiments described above are implemented by the plurality of electronic components 7. For example, an electronic component 7 may include the resonator element 2 and an integrated circuit having the functions of the oscillation circuit 10, the frequency divider circuit 11, and the timing circuit 12. Another electronic component 7 may include the temperature sensor 19. In addition, another electronic component 7 may include an integrated circuit having the function of the processor 14 or an integrated circuit having the function of the memory circuit 16. Further, another electronic component 7 may be the battery 4 or the sensor 6.

According to the present modification, similarly to each of the above-described embodiments, since a ceramic package is used as the package 40, the exterior is extremely hard and strong. Therefore, for example, it is possible to provide the robust temperature logger 1 in which damage, a defect, or the like is unlikely to occur even if an impact is applied during transport. In addition, since the wiring can be routed inside the package 40, a printed circuit substrate or the like is not required. Further, since the package 40 enables hermetic sealing, it is not necessary to package each electronic component 7. As a result, the temperature logger 1 can be reduced in size, resources can also be reduced, and thus the cost can be reduced.

In the example illustrated in FIG. 14, the plurality of electronic components 7 are housed in the package 40 such as a ceramic package, but may be housed in a mold package. FIG. 15 is a cross-sectional view illustrating an example of a structure of a temperature logger 1 according to the present modification. In the example illustrated in FIG. 15, the plurality of electronic components 7 are mounted on the substrate 70, and the plurality of electronic components 7 are fixed with a mold resin 80. For example, the material of the substrate 70 may be a ceramic. In addition, the substrate 70 may be a PCB substrate. PCB is an abbreviation for Printed Circuit Board.

According to the present modification, since the plurality of electronic components 7 are fixed with the mold resin 80, a solid structure is obtained, and a resonance frequency can be increased. In addition, since the ceramic is extremely hard, the resonance frequency of the exterior can be increased by using the ceramic as the material of the substrate 70. In addition, since the substrate 70 is a PCB substrate, the temperature logger 1 can be manufactured at a low cost.

The above-described embodiments and modifications are merely examples, and the present disclosure is not limited thereto. For example, each of the embodiments and each of the modifications may be combined as appropriate.

The present disclosure includes configurations that are substantially the same as the configurations described in the embodiments, for example, a configuration having the same functions, methods, and results as those in the embodiments, or a configuration having the same purposes and effects as those in the embodiments. In addition, the present disclosure includes configurations in which non-essential components of the configurations described in the embodiments are replaced. In addition, the present disclosure includes configurations that produce the same operational effects as those of the configurations described in the embodiments or configurations that can obtain the same objects as those of the configurations described in the embodiments. Further, the present disclosure includes configurations in which a known technique is added to the configurations described in the embodiments.

The following contents are derived from the above-described embodiments and the modifications.

In one aspect, a temperature logger includes a circuit device and a package housing the circuit device, the circuit device includes a timing circuit that tracks time to generate time data, a temperature sensor that detects a temperature and outputs a temperature signal corresponding to the detected temperature, and a memory circuit that stores time information based on the time data and temperature information based on the temperature signal in association with each other, and the temperature logger has a heat capacity less than or equal to 0.4 [J/K].

Since this temperature logger has the extremely low heat capacity, a fluctuation in the temperature of an object to be measured is small even in a case where the temperature logger is attached to the object that is to be measured and whose temperature is constant. In addition, in a case where the temperature logger is attached to an object that is to be measured and whose temperature rapidly changes, performance in tracking the temperature of the object to be measured is not inhibited. Therefore, according to this temperature logger, it is possible to accurately measure and record the temperature of an object to be measured.

In one aspect, in the temperature logger, the heat capacity may be less than or equal to 0.16 [J/K].

According to this temperature logger, since the heat capacity is further lower, it is possible to more accurately measure and record the temperature of the object to be measured.

In one aspect, in the temperature logger, the heat capacity may be less than or equal to 0.06 [J/K].

According to this temperature logger, since the heat capacity is further lower, it is possible to more accurately measure and record the temperature of the object to be measured.

In one aspect, in the temperature logger, the heat capacity may be less than or equal to 1/100 of a heat capacity of an object to be measured.

According to this temperature logger, it is possible to accurately measure and record the temperature of the object, which is to be measured, with an error of ±1% or less.

In one aspect, in the temperature logger, the time information may be data corresponding to one or more of time digits of the time data.

According to this temperature logger, since the number of digits of the time information can be set to the minimum necessary number of digits, it is possible to reduce the amount of data stored in the memory circuit.

In one aspect, the temperature logger may further include a resonator element, the circuit device may include an oscillation circuit that vibrates the resonator element, and the resonator element may be housed in the package.

In one aspect, the temperature logger may further include a battery that supplies electric power to the circuit device, and the battery may be housed in the package.

According to the temperature logger, since it is not necessary for a user to prepare a battery, it is possible to improve convenience.

In one aspect, in the temperature logger, the package may have dimensions of 7 mm×5 mm, 5 mm×3.2 mm, or 3.2 mm×2.5 mm in plan view.

According to the temperature logger, since the package is widely used, it is possible to improve convenience and versatility.

What is claimed is:

1. A temperature logger comprising:
a circuit device; and
a package housing the circuit device, wherein
the circuit device includes
a timing circuit that tracks time to generate time data,
a temperature sensor that detects a temperature and outputs a temperature signal corresponding to the detected temperature, and
a memory circuit that stores time information based on the time data and temperature information based on the temperature signal in association with each other, and
the temperature logger has a heat capacity less than or equal to 0.4 [J/K].

2. The temperature logger according to claim 1, wherein
the heat capacity is less than or equal to 0.16 [J/K].

3. The temperature logger according to claim 2, wherein
the heat capacity is less than or equal to 0.06 [J/K].

4. The temperature logger according to claim 1, wherein
the heat capacity is less than or equal to 1/100 of a heat capacity of an object to be measured.

5. The temperature logger according to claim 1, wherein
the time information is data corresponding to one or more of time digits of the time data.

6. The temperature logger according to claim 1, further comprising
a resonator element, wherein
the circuit device includes an oscillation circuit that vibrates the resonator element, and
the resonator element is housed in the package.

7. The temperature logger according to claim 1, further comprising
a battery that supplies electric power to the circuit device, wherein
the battery is housed in the package.

8. The temperature logger according to claim 1, wherein
the package has dimensions of 7 mm×5 mm, 5 mm×3.2 mm, or 3.2 mm×2.5 mm in plan view.
